(19) United States
(12) Patent Application Publication
(10) Pub. No.: US 2010/0059901 A1
(43) Pub. Date: Mar. 11, 2010

(54) OPTICAL FIBER CONNECTING ELEMENT AND MOLDING APPARATUS AND METHOD FOR PRODUCING THE SAME

(75) Inventor: Michihiro TAKAMATSU, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/555,074

(22) Filed: Sep. 8, 2009

(30) Foreign Application Priority Data
Sep. 9, 2008 (JP) 2008-230662

(51) Int. Cl. B28B 1/14; B29C 37/00

(52) U.S. Cl. 264/138

(57) ABSTRACT

A method for producing an optical fiber connecting element including a main body having an optical fiber insertion hole and a guide pin insertion hole, the method includes: molding by feeding a material of the optical fiber connecting element with a pin holder having a pin for forming the optical fiber insertion hole and a pin for forming the guide pin insertion hole placed in a certain position of a mold having a cavity having a shape corresponding to a shape in which light exits of the main bodies of a pair of the optical fiber connecting elements face each other, filling the cavity with the material, and then opening the mold; and producing a pair of the optical fiber connecting elements by cutting a molded body formed by the molding.

This application is based upon and claims the benefit of priority from the prior Japanese Patent Application No. 2008-230662 filed on Sep. 9, 2008, the entire contents of which are incorporated herein by reference.

### BACKGROUND

1. Field

The present invention relates to an optical fiber connecting element provided with a main body having an optical fiber insertion hole through which an optical fiber is inserted and a guide pin insertion hole through which a guide pin is inserted, and to a molding apparatus and a method for producing the optical fiber connecting element.

2. Description of Related Art

In recent years, as one of the methods for connecting the ends of optical fibers, a method by which the end of the optical fiber is made to take the form of a connector has been known.

A ferrule is known as a component for positioning and fixing the end of an optical fiber to make it easy to perform positioning of the ends of the optical fibers and to maintain a connection state at the time of making the optical fiber end take the form of a connector.

FIG. 9 illustrates a common method for producing a ferrule. As illustrated in FIG. 9, a lower mold 90 has, at one end thereof, a plurality of (four) V-shaped grooves 92 in which a plurality of (for example, four) pins 91 for forming an optical fiber insertion hole are to be placed and a plurality of (two) V-shaped grooves 94 in which a plurality of (for example, two) pins 93 for forming a guide pin insertion hole are to be placed.

According to this ferrule production method using the lower mold 90, an upper mold (not shown) and the lower mold 90 are closed with each pin 91 for forming an optical fiber insertion hole placed in a corresponding one of the V-shaped grooves 92 of the lower mold 90 and each pin 93 for forming a guide pin insertion hole placed in a corresponding one of the V-shaped grooves 94 of the lower mold 90. Then, thermosetting or thermoplastic resin is injected into the closed upper and lower molds and is cured or plasticized, whereby a ferrule for an optical connector is formed by molding.

### SUMMARY

According to an embodiment of the present invention, a method for producing an optical fiber connecting element including a main body having an optical fiber insertion hole and a guide pin insertion hole, the method includes: molding by feeding a material of the optical fiber connecting element with a pin holder having a pin for forming the optical fiber insertion hole and a pin for forming the guide pin insertion hole placed in a certain position of a mold having a cavity with a shape corresponding to a shape in which light exits of the main bodies of a pair of the optical fiber connecting elements face each other, filling the cavity with the material, and then opening the mold; and producing a pair of the optical fiber connecting elements by cutting a molded body formed by the molding.

It is to be understood that both the foregoing summary description and the following detailed description are explanatory as to some embodiments of the present invention, and not restrictive of the present invention as claimed.

### BRIEF DESCRIPTION OF THE DRAWINGS

FIG. 1 illustrates an optical connector of the embodiment.

FIG. 2 illustrates a ferrule of the embodiment.

FIG. 3 illustrates the ferrule over which a connector has yet to be fitted.

FIG. 4 illustrates a mold of the embodiment.

FIG. 5 illustrates a sectional view of a state in which a cavity is formed.

FIG. 6 illustrates a molded body formed by molding.

FIGS. 7A and 7B illustrate one specific example of the ferrule.

FIGS. 8A and 8B illustrate another specific example of the ferrule.

FIG. 9 illustrates a common method for producing a ferrule.

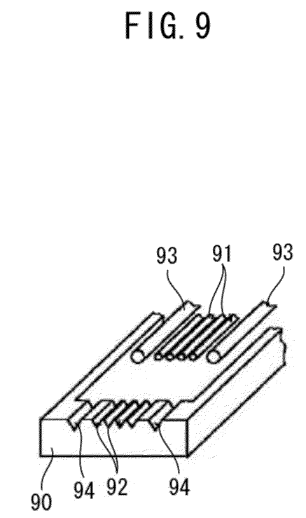

### DETAILED DESCRIPTION OF EMBODIMENTS

Hereinafter, an embodiment will be described in detail with reference to the drawings.

### <Optical Connector>

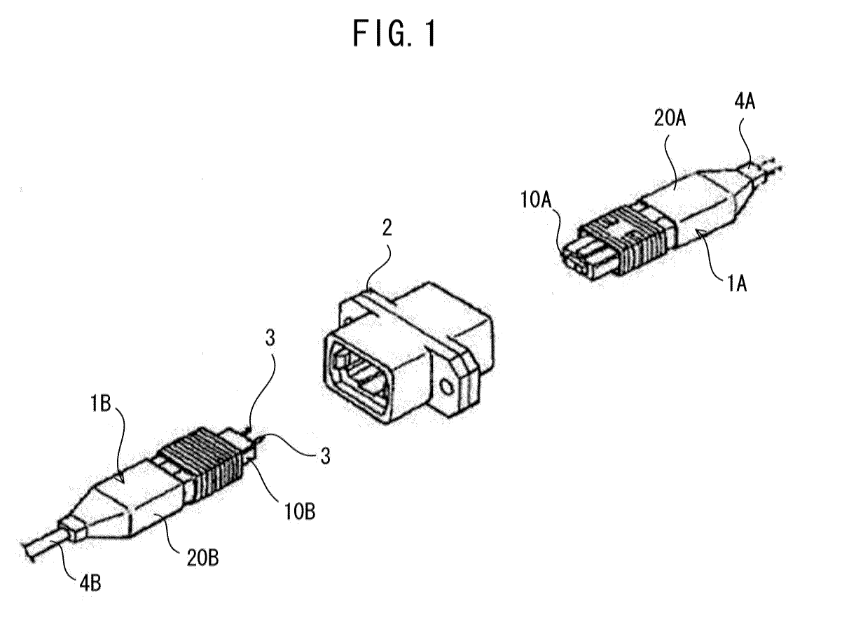

FIG. 1 illustrates an optical connector of the embodiment. Optical connectors 1A and 1B are multifiber connectors having the same shape. The optical connector 1A has a ferrule (optical fiber connecting element) 10A provided at the tip thereof and a housing 20A fixing the ferrule 10A. Moreover, the optical connector 1B has a ferrule 10B provided at the tip thereof and a housing 20B fixing the ferrule 10B.

Tape optical fibers 4A and 4B, each being a bundle of a plurality of optical fibers, are inserted into the housings 20A and 20B respectively. The ferrule 10B has a guide pin insertion hole into which a guide pin 3 is inserted. The guide pin insertion hole will be described later.

When the optical connectors 1A and 1B are inserted into an adapter 2, they are fixed to the adapter 2. At this time, the guide pin 3 is inserted into a guide pin insertion hole of the ferrule 10A, whereby optical fiber insertion holes, which will be described later, of the ferrules 10A and 10B are supported in such a way as to face each other.

As a result, the light incident on the tape optical fiber 4A (4B) exits from the tape optical fiber 4B (4A).

### <Ferrule>

Next, the structure of the ferrule will be described. Since the ferrules 10A and 10B have the same structure, as a typical example, the structure of the ferrule 10A is described.

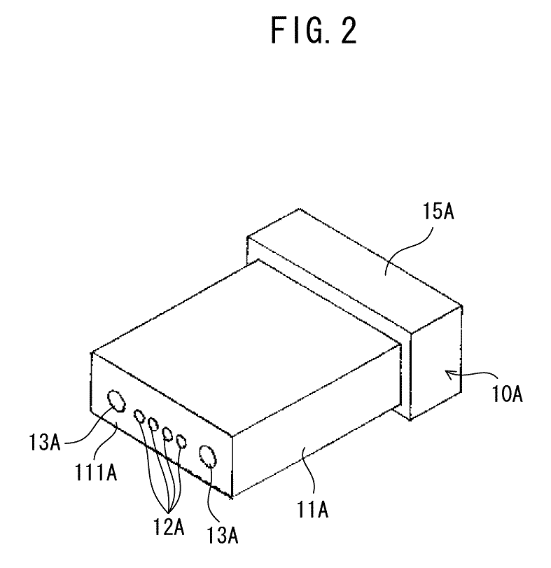

FIG. 2 illustrates the ferrule of the embodiment. The ferrule 10A has a rectangular main body 11A and a supporting section 15A. Although the constituent material of the ferrule 10A is not particularly limited, the materials may include, for example, thermoplastic resins such as polyethylene, polypropylene, polyolefin, polystyrene, polyamide, thermoplastic polyimide, and polycarbonate, or thermosetting resins such as epoxy resin, phenolic resin, urea resin, melamine resin, polyester resin, polyimide resin, silicone resin, and polyurethane resin.

The main body 11A has a plurality of (in FIG. 2, four) optical fiber insertion holes 12A into which optical fibers (not shown) are inserted, the optical fiber insertion holes 12A each having an exit from which the light of the inserted optical fiber exits, and a pair of guide pin insertion holes 13A into which the guide pins 3 are inserted.

Each optical fiber insertion hole 12A extends from an end face 111A toward the inside of the main body 11A. Although the radius of each optical fiber insertion hole 12A is not particularly limited, the radius may be approximately 0.125 mm, for example. Moreover, although the pitch between the optical fiber insertion holes 12A is not particularly limited, the pitch may be approximately 0.25 mm, for example.

The guide pin insertion holes 13A extend parallel to the optical fiber insertion holes 12A from the end face 111A toward the inside of the main body 11A. The guide pin insertion holes 13A are each provided in such a way that the center of the hole lies in an extension of a straight line connecting the centers of the optical fiber insertion holes.

Furthermore, although the radius of the guide pin insertion hole 13A is not particularly limited, of the radius may be approximately 0.7 mm, for example.

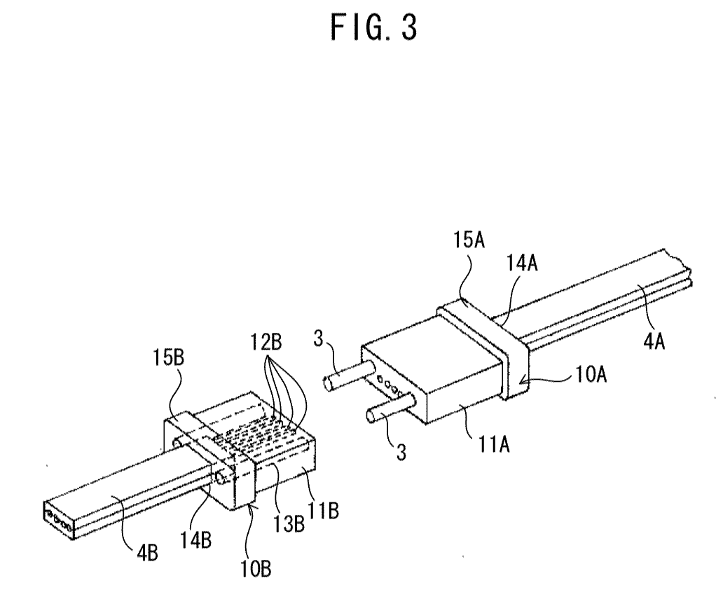

FIG. 3 illustrates the ferrule over which a connector has yet to be fitted. The ferrules 10A and 10B each have openings for inserting the tape optical fibers 4A and 4B respectively on the back faces, and are respectively provided with concave sections 14A and 14B having a specific depth.

The ferrule 10B will be described as an example. The tape optical fiber 4B has, at the tip thereof, four exposed optical fibers. When the tape optical fiber 4B is inserted into the concave section 14B, the exposed optical fibers of the tape optical fiber 4B are inserted into the optical fiber insertion holes 12B of the main body 11B. The light incident on the tape optical fiber 4B exits from the above-described exits.

The ferrules 10A and 10B are filled with an adhesive. With this adhesive, the optical fibers inserted into the optical fiber insertion holes 12B are firmly fixed to the ferrules 10A and 10B.

Next, a method for producing the ferrules 10A and 10B of the embodiment will be described.

### <Mold>

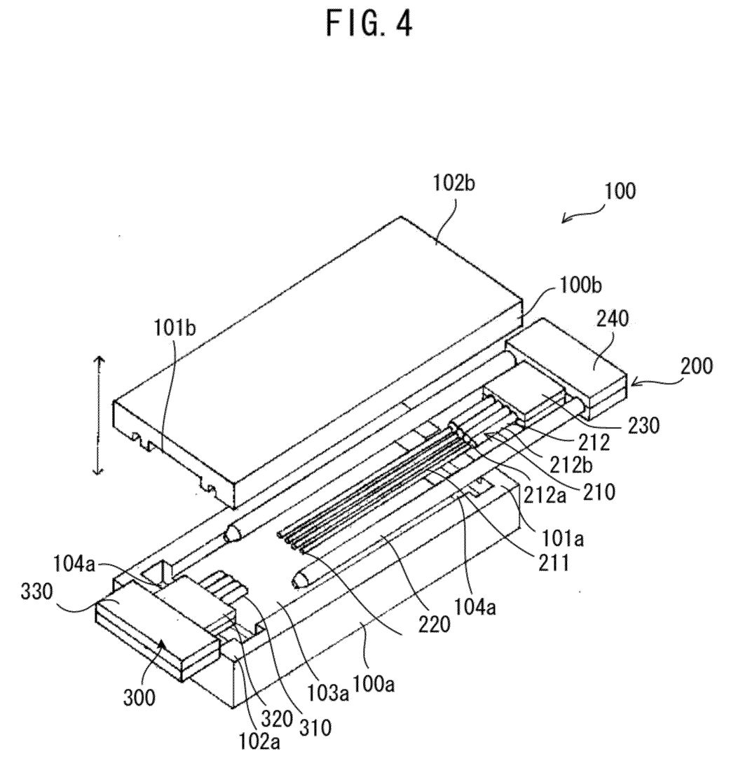

FIG. 4 is a diagram of a mold of the embodiment. A mold 100 is used for producing the ferrules 10A and 10B one at a time, and has a lower mold 100a and an upper mold 100b.

At ends 101a and 102a of the lower mold 100a in the direction of the longer sides thereof, concave sections for supporting (certain positions of) a pin holder 200 and a pin holder 300, respectively, are provided.

Also at ends 101b and 102b of the upper mold 100b in the direction of the longer sides thereof, concave sections for supporting (predetermined positions of) the pin holder 200 and the pin holder 300, respectively, are provided.

The lower mold 100a and the upper mold 100b have patterns formed therein so as to correspond to the external shapes of the ferrules 10A and 10B. Specifically, a concave section 103a corresponding to the main bodies 11A and 11B and concave sections 104a corresponding to the supporting sections 15A and 15B are formed. The concave sections 104a are deeper than the concave section 103a.

### <Pin Holder>

The pin holder 200 has four pins 210 for forming an optical fiber hole, a pin 220 for forming a guide hole, a supporting section 230 supporting the pins 210 for forming an optical fiber hole, and a holding section 240.

The pins 210 for forming an optical fiber hole are arranged in parallel at a specific pitch. The constituent materials of the pins 210 for forming an optical fiber hole include various metals for example. Each pin 210 for forming an optical fiber hole has a rod-like optical fiber hole forming section 211 extending from the tip thereof and a base end section 212 connected to the supporting section 230.

Although the outside diameter of the optical fiber hole forming section 211 is not particularly limited, of the outside diameter may be approximately 0.125 mm, for example.

The length of the pin 210 for forming an optical fiber hole is set so that the tip of the optical fiber hole forming section 211 makes contact with the tip of a pin 310 for forming an optical fiber hole, which will be described later, when the pin holder 200 slides toward the end 102a and the holding section 240 makes contact with the end 101a of the lower mold 100a.

The base end section 212 has a tapered section 212a whose diameter gradually increases toward the base end and a part 212b formed of a part having a constant outside diameter. The base end section 212 is connected to the optical fiber hole forming section 211 through the tapered section 212a.

The pin 220 for forming a guide hole is provided parallel to the pins 210 for forming optical fiber holes. The length of the pin 220 for forming a guide hole is set so that the tip of the pin 220 for forming a guide hole is located at the end 102a of the lower mold 100a when the pin holder 200 slides toward the end 102a and the holding section 240 makes contact with one end of the lower mold.

The tip of the pin 220 for forming a guide hole may pierce through the end 102a of the lower mold 100a and stick out therefrom. The holding section 240 is the part which is held when the pin holder 200 is slid into position.

The pin holder 300 has a pin 310 for forming an optical fiber hole, a supporting section 320, and a holding section 330. The length of the pin 310 for forming an optical fiber hole is the same as the length of the base end section 212 of the pin 210 for forming an optical fiber hole.

The structures (shapes) of the supporting section 320 and the holding section 330 are the same as those of the supporting section 230 and the holding section 240 respectively.

### <Production Method>

Next, a method for producing the ferrule of the embodiment by using the mold 100, the pin holder 200, and the pin holder 300 will be described.

[1] First, the supporting section 320 is placed in the concave section formed at the end 102a of the lower mold 100a by holding the holding section 330 of the pin holder 300.

[2] Next, the pin holder 200 is inserted from the end 101a of the lower mold 100a by holding the holding section 240 thereof, and is slid along the longer sides of the lower mold 100a. As a result, the optical fiber hole forming section 211 makes contact with the pin 310 for forming an optical fiber hole of the pin holder 300, and the supporting section 230 is supported by the end 101a.

Moreover, the tip of the pin 220 for forming a guide hole is located at the end 102a of the lower mold 100a.

[3] In this state, the upper mold 100b is placed on the lower mold 100a, whereby a cavity is formed inside the mold 100.

The pin holder 200 may be inserted with the upper mold 100b placed on the lower mold 100a.

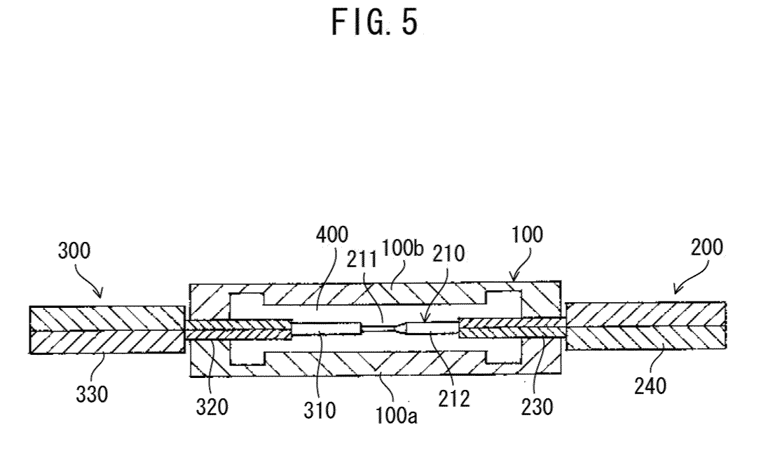

FIG. 5 is a sectional view illustrating a state in which a cavity is formed. The pin 210 for forming an optical fiber hole and the pin 310 for forming an optical fiber hole are located in areas which will become the optical fiber insertion holes 12A and 12B in the cavity 400. The supporting sections 230 and 320 are located in areas which will become the concave sections 14A and 14B in the cavity 400.

In this state, the pin 210 for forming an optical fiber hole does not require fine positioning. This helps make the production easy.

[4] In this state, the above-mentioned thermosetting or thermoplastic resin material in the molten state is injected from an injection opening (not shown) so that the cavity 400 is filled with the resin material, and then the resin material is cured or plasticized.

As a result, a molded body corresponding to the cavity 400 formed inside the mold 100 is formed by molding.

[5] Then, the pin holder 200 and the pin holder 300 are pulled in a direction opposite to an insertion direction, and the molded body is detached by removing the upper mold 100b.

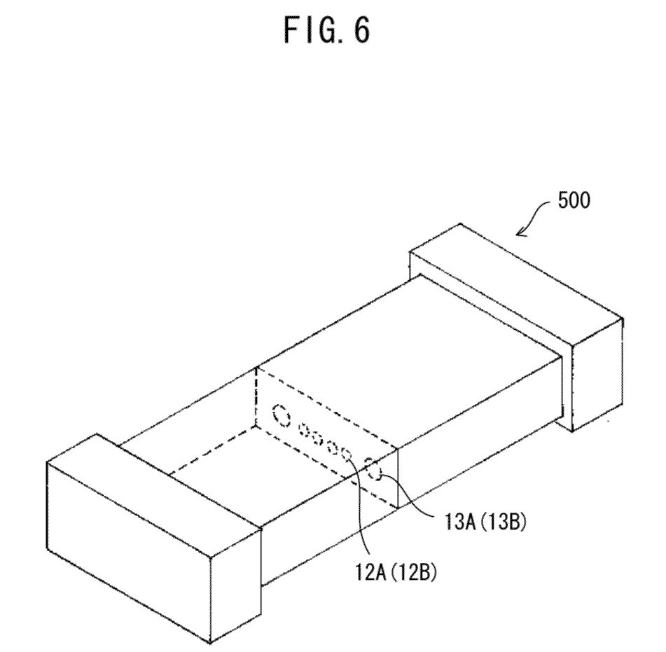

FIG. 6 is a diagram illustrating the molded body formed by molding.

A molded body 500 has the same shape as the shape of a pair of ferrules 10A and 10B facing each other.

The molded body 500 has formed therein holes which will become the optical fiber insertion holes 12A and 12B and holes which will become the guide pin insertion holes 13A and 13B.

[6] Next, the molded body 500 is cut into two parts in such a way that the two parts have a symmetrical shape (in such a way that the main bodies of the ferrules have the shame shape). As a result, a pair of ferrules 10A and 10B is obtained.

As described above, according to the production method of this embodiment, since the molded body 500 is produced and is then cut to produce a pair of ferrules 10A and 10B, it is possible to produce a high-precision ferrule (with low light loss).

Optical connectors obtained by using ferrules obtained from separate molded bodies 500 may be connected to each other by the adapter 2. However, in particular, when a pair of optical connectors provided with two ferrules obtained from one molded body 500 are connected to each other by the adapter 2, the loss of light is reduced.

Moreover, since production can be performed without consideration of the positional accuracy of the pin 210 for forming an optical fiber hole, it is possible to make the production easy.

Furthermore, previously, the optical fiber insertion hole and the guide pin insertion hole were arranged so as to be aligned to ensure positional accuracy. However, this production method eliminates the need to do so and allows the optical fiber insertion hole to be arranged with relatively high flexibility as compared to the conventional method. In addition, it is possible to increase the number of optical fiber insertion holes easily. A specific example is described below.

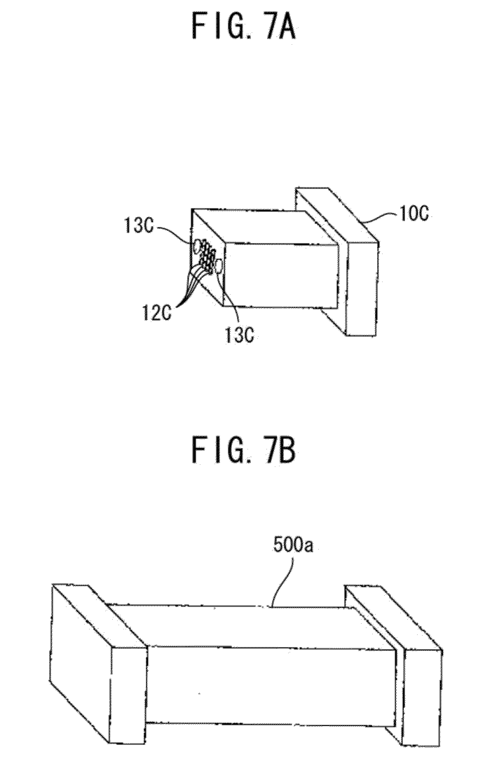

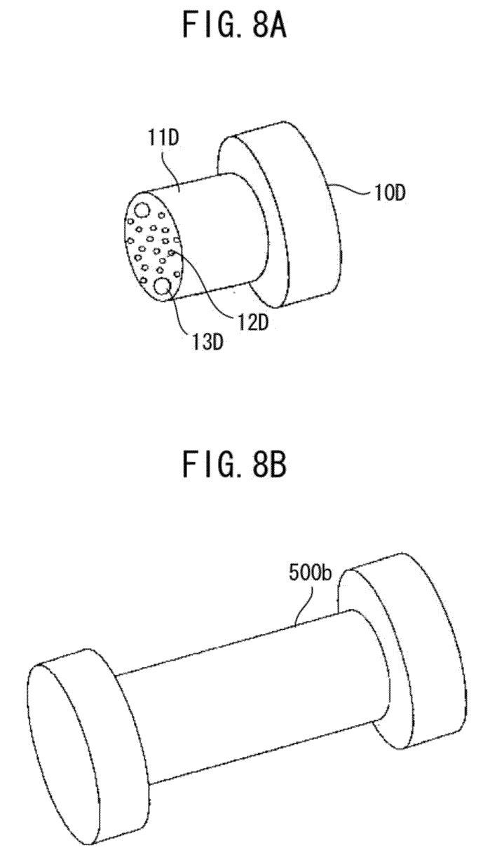

FIGS. 7A, 7B and 8A, 8B illustrate specific examples of the ferrule. A ferrule 10C illustrated in FIG. 7A has optical fiber insertion holes 12C arranged in a matrix. Such a ferrule may be produced as follows. Pins for forming an optical fiber hole, the pins of a guide pin of a pin holder 200 (a transmission side), and pins for forming an optical fiber hole, the pins of a guide pin of a pin holder 300 (a reception side), are arranged in a matrix, and these pins are made to make contact each other at the time of production, whereby a molded body 500a illustrated in FIG. 7B is obtained. Then, the molded body 500a thus obtained is cut.

A ferrule 10D illustrated in FIGS. 8A and 8B has a cylindrical main body 11D, and has a circular cross-sectional shape. Moreover, a plurality of optical fiber insertion holes 12D and guide pin insertion holes 13D are arranged in irregular positions. Such a ferrule may be obtained by preparing a mold that can form a cavity having a shape corresponding to the cylindrical shape of the ferrule 10D and pins for forming an optical fiber hole, the pins corresponding to the positions of the optical fiber insertion holes 12D and the guide pin insertion holes 13D, and cutting a molded body 500b obtained by the same method as the above-described production method.

According to the ferrule 10D described above, it is possible to obtain a ferrule that may connect more optical fibers as compared to the ferrule 10A or the like.

Although the descriptions heretofore deal with a method for producing an optical fiber connecting element, a molding apparatus, and an optical fiber connecting element of the present invention based on the embodiment shown in the drawings, the present invention is not limited thereto. It is to be understood that the configuration of each section may be replaced with any configuration having a similar function. Moreover, any other component or process may be added to the present invention.

Moreover, the present invention may be a combination of any two or more configurations (features) of the above-described embodiment.

The embodiment described above is a preferred embodiment. The present invention is not limited to this but various modifications can be made without departing from the spirit of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions has been described in detail, it should be understood that the various changes, substitutions, and alterations could be made hereto without departing from the spirit and scope of the invention.

What is claimed is:

1. A method for producing an optical fiber connecting element including a main body having an optical fiber insertion hole through which an optical fiber is inserted and a guide pin insertion hole through which a guide pin is inserted, the method comprising:
molding by feeding a material of the optical fiber connecting element with a pin holder having a pin for forming the optical fiber insertion hole and a pin for forming the guide pin insertion hole placed in a certain position of a mold having a cavity with a shape corresponding to a shape in which light exits of the main bodies of a pair of the optical fiber connecting elements face each other, filling the cavity with the material, and then opening the mold; and
producing a pair of the optical fiber connecting elements by cutting a molded body formed by the molding.

2. The method for producing an optical fiber connecting element according to claim 1, wherein
in a state where the pin holder is placed in a certain position of the mold, the pin for forming the optical fiber insertion hole and the pin for forming the guide pin insertion hole, the pins being of the pin holder, are placed in positions which will become the optical fiber insertion hole and the guide pin insertion hole of each of a pair of the optical fiber connecting elements.

3. The method for producing an optical fiber connecting element according to claim 1, wherein
the pin for forming the optical fiber insertion hole, the pin being of the pin holder, comprises a plurality of pins arranged irregularly.

4. The method for producing an optical fiber connecting element according to claim 1, wherein
the pin for forming the optical fiber insertion hole, the pin being of the pin holder, comprises a plurality of pins arranged in a matrix.

5. A molding apparatus for producing an optical fiber connecting element including a main body having an optical fiber insertion hole through which an optical fiber is inserted and a guide pin insertion hole through which a guide pin is inserted, the apparatus comprising:
a mold having a cavity with a shape corresponding to a shape in which light exits of the main bodies of a pair of the optical fiber connecting elements face each other;
a pin holder having a pin for forming the optical fiber insertion hole of the pair of the optical fiber connecting elements and a pin for forming the guide pin insertion hole;
a molding unit that feeds a material of the optical fiber connecting element in a state where the pin holder is placed in a certain position of the mold, fills the cavity with the material, and opens the mold to perform molding.

6. An optical fiber connecting element including a main body having an optical fiber insertion hole through which an optical fiber is inserted and a guide pin insertion hole through which a guide pin is inserted, the element produced by a method comprising:
preparing a mold having a cavity with a shape corresponding to a shape in which light exits of the main bodies of a pair of the optical fiber connecting elements face each other;
preparing a pin holder having a pin for forming the optical fiber insertion hole and a pin for forming the guide pin insertion hole;
feeding a material of the optical fiber connecting element in a state where the pin holder is placed in a certain position of the mold, and filling the cavity with the material; and
opening the mold to perform molding.
